(19) United States
(12) Patent Application Publication
(10) Pub. No.: US 2024/0160702 A1
(43) Pub. Date: May 16, 2024

(54) METHOD FOR MANAGING DOCUMENT TO BE CLEANED BASED ON METADATA OF SECURE DOCUMENT, APPARATUS FOR THE SAME, COMPUTER PROGRAM FOR THE SAME, AND RECORDING MEDIUM STORING COMPUTER PROGRAM THEREOF

(71) Applicant: FASOO INC., Bethesda, MD (US)

(72) Inventors: Kwang Hoon KIM, Seoul (KR); Jeong Moon OH, Seoul (KR); Jung Hyun CHO, Seoul (KR); Soo Yong LEE, Incheon (KR); Jae Hyun PARK, Seoul (KR)

(21) Appl. No.: 18/500,985

(22) Filed: Nov. 2, 2023

(30) Foreign Application Priority Data
Nov. 15, 2022 (KR) 10-2022-0152783

(51) Int. Cl. G06F 21/10

(52) U.S. Cl. CPC G06F 21/106

(57) ABSTRACT

The present disclosure relates to managing a document to be cleaned, includes processing a request, in response to the request to store document data of a first document in a database, based on at least one of whether the first document is duplicate or whether substantive contents of the first document are a same in a relationship with a second document pre-stored in the database, whether the first document is duplicate may be determined by comparing a unique identification value and version information of the first document with a unique identification value and version information of the second document, and whether substantive contents of the first document are the same may be determined by comparing hash data of the first document with hash data of the second document.

### CROSS-REFERENCE TO RELATED APPLICATIONS

This application claims the benefit of earlier filing date and right of priority to Korean Application No. 10-2022-0152783, filed on Nov. 15, 2022, the contents of which are all hereby incorporated by reference herein in their entirety.

### TECHNICAL FIELD

The present disclosure relates to a method, a device, a computer program and a recording medium for managing a document to be cleaned based on metadata of a secure document, and in more detail, develops a technology for effectively managing unnecessary information by determining a use rate of a document and metadata of digital rights management (DRM).

### BACKGROUND ART

As use of an electronic document has increased, a requirement for integrating and managing it has occurred and systems such as enterprise content management (ECM) or enterprise document management (EDM), etc. have been released to satisfy such a requirement.

### DISCLOSURE

### Technical Problem

Systems such as ECM and EDM above can effectively search and manage an electronic document, but due to a difficulty in continuous document registration and search, long-term unused documents have increased along with data redundancy. It required continuous storage expansion and resulted in slowdown and unnecessary waste of resources.

Meta information is added to a distributed document to identify a document and a similar document is determined through a use rate of a document and identification information of a document, preventing a duplicate document from continuously increasing.

### Technical Solution

A method, a device and a computer readable recording medium for managing a document to be cleaned according to an embodiment of the present disclosure include a database storing document data of a document, wherein metadata of the document data includes a unique identification value identifying the document, version information representing a version of the document and hash data related to contents of the document, and a control unit which performs a request, in response to the request to store document data of a first document in the database, based on at least one of whether the first document is duplicate or whether substantive contents of the first document are a same in a relationship with a second document pre-stored in the database, and whether the first document is duplicate may be determined by comparing a unique identification value and version information of the first document with a unique identification value and version information of the second document, and whether substantive contents of the first document are the same may be determined by comparing hash data of the first document with hash data of the second document.

In a method, a device and a computer readable recording medium for managing a document to be cleaned according to an embodiment of the present disclosure, when a unique identification value and version information of the first document are the same as a unique identification value and version information of the second document, in a relationship with the second document, the first document may be determined as a duplicate document, and when at least one of a unique identification value or version information of the first document and the second document is different, in a relationship with the second document, the first document may be determined as a non-duplicate document.

In a method, a device and a computer readable recording medium for managing a document to be cleaned according to an embodiment of the present disclosure, when hash data of the first document is the same as hash data of the second document, substantive contents of the first document may be determined to be the same as the second document, and when hash data of the first document is different from hash data of the second document, substantive contents of the first document may be determined to be different from the second document.

In a method, a device and a computer readable recording medium for managing a document to be cleaned according to an embodiment of the present disclosure, when the device for managing a document to be cleaned is a server, the first document is a document requested to be registered on the server by a client connected to the server or the server, and a request to store document data of the first document in the database may include a request to store document data of the first document in a database of the server.

In a method, a device and a computer readable recording medium for managing a document to be cleaned according to an embodiment of the present disclosure, when the device for managing a document to be cleaned is a client connected to a server, the first document is a document downloaded from the server, and a request to store document data of the first document in the database may include a request to store document data of the first document in a database of the client.

In a method, a device and a computer readable recording medium for managing a document to be cleaned according to an embodiment of the present disclosure, when document data of the first document is stored in a database of the client according to a request to store document data of the first document in the database, validity of the first document stored in a database of the client may be determined based on a unique identification value of the first document per certain period.

In a method, a device and a computer readable recording medium for managing a document to be cleaned according to an embodiment of the present disclosure, when a request to store document data of the first document in the database is performed, the control unit may determine a use rate of the first document per certain period.

In a method, a device and a computer readable recording medium for managing a document to be cleaned according to an embodiment of the present disclosure, metadata of the document may further include document classification information representing a type of the document, the certain period may be determined according to importance of the first document and importance of the first document may be determined based on document classification information of the first document.

In a method, a device and a computer readable recording medium for managing a document to be cleaned according to an embodiment of the present disclosure, metadata of the document may further include a frequency of use and a use period of the document and a determination on a use rate of the first document may be performed based on a frequency of use and a use period of the first document.

In a method, a device and a computer readable recording medium for managing a document to be cleaned according to an embodiment of the present disclosure, when a use rate of the first document is smaller than a threshold value, the control unit may identify the first document as a document to be removed and delete it from the database.

### Technical Effects

In the present disclosure, a method, a device, a computer program and a recording medium for managing a document to be cleaned based on metadata have an effect of reducing system operating costs by minimizing waste of storage space of a document management system to efficiently manage a document management system.

A method, a device, a computer program and a recording medium for managing a document to be cleaned based on metadata in the present disclosure may be used together on a user's PC, so a user's document increased at work may be effectively managed.

### DESCRIPTION OF DRAWINGS

FIG. 1 is an exemplary diagram showing a structure of document data.

FIG. 2 is an exemplary diagram showing a structure of a server.

FIG. 3 is an exemplary diagram showing a structure of a client.

FIG. 4 is a diagram for a method for managing a document to be cleaned of a server.

FIG. 5 is a diagram for a method for managing a document to be cleaned of a client.

### BEST MODE

Hereinafter, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “coupled”, or “accessed” to another element, it is understood to include not only a direct connection relationship but also an indirect connection relationship. Also, when an element is referred to as “containing” or “having” another element, it means not only excluding another element but also further including another element.

In the present disclosure, the terms “first”, “second”, and so on are used only for the purpose of distinguishing one element from another, and do not limit the order or importance of the elements unless specifically mentioned. Thus, within the scope of this disclosure, the first component in one embodiment may be referred to as a second component in another embodiment, and similarly a second component in one embodiment may be referred to as a second component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in one embodiment are also included within the scope of this disclosure. Also, embodiments that include other components in addition to the components described in the various embodiments are also included in the scope of the present disclosure.

In the present disclosure, ‘document’ may include both an encrypted secure document and an unencrypted general document. Hereinafter, for convenience of a description, everything is described as ‘document’, but the ‘document’ may be applied equally to ‘a secure document’.

In the present disclosure, a device for managing a document to be cleaned may include a server or a client connected to the server.

In the present disclosure, storing a document may include at least one of storing data of a document itself or storing metadata which may identify a document.

In the present disclosure, document data of a document may include at least one of data of a document itself or metadata of a document for substantive contents of a document. For convenience of a description, it is described below as document data.

Metadata of a document may include basic information of a document to identify a document and other additional information of a document. As an example, metadata of a document may include a unique identification value of a document, version information of a document, hash data of a document, creator information about a creator of a document, encryption information about encryption of a document, right information of a document showing a sharing target of a document, classification information of a document, etc.

Hash data may be data having a fixed length which is mapped by applying a hash function to contents having various lengths.

Accordingly, when hash data of two documents is the same, contents of the two documents may be the same. In contrast, when hash data of two documents is different from each other, contents of the two documents may be different.

Classification information of a document may include a pre-defined code showing a type of a document.

Except in a special case (when a server recognizes an exception, etc.), different documents may not have an identification value of the same document and version information of a document, so basic information of a document for identifying a document may include an identification value of a document and version information of a document. Accordingly, an identification value of a document and version information of a document may be key information in determining whether it is a duplicate document which will be described later.

In the present disclosure, the following items may be determined as a standard for determining whether a document is subject to organization (=usability of a document).
1. Whether a formally and/or substantially identical document exists
2. How often a document is used

Whether a formally identical document of the present disclosure exists represents whether a document is duplicate and may be determined based on whether an identification value and version information of a document are the same.

Whether a substantially identical document of the present disclosure exists represents whether substantive contents of a document are the same and may be determined based on whether hash data of a document is the same.

In other words, a determination on whether a document of the present disclosure is duplicate may include at least one of a determination on whether the document is formally duplicate or a determination on whether the substantive contents are the same.

A determination on whether a document is subject to organization may be performed on a server or a client connected to a server when using a document or at a specific period.

Here, use of a document may include all commands for a document such as reading, writing, etc. of a document. For example, use of a document in the present disclosure may include reading a document, editing a document, etc.

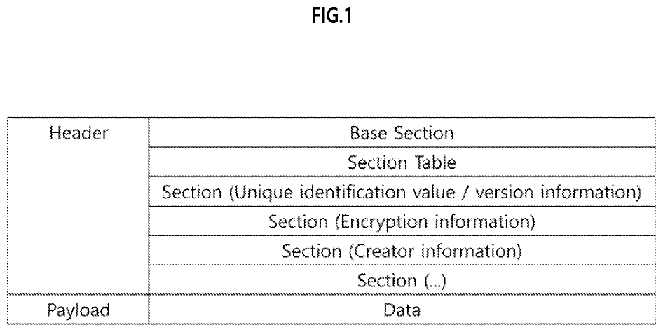

FIG. 1 is an exemplary diagram showing a structure of document data.

Document data may include at least one of a header or a payload. A document data structure of FIG. 1 may be used for data exchange between servers or clients through a network.

In a header of a document, metadata of a document may be stored per section. For example, a header of a document may include at least one of a first section having data of a unique identification value and version information, a second section having data of encryption information related to encryption of a document, a third section having data of creator information of a document, a fourth section having data of modifier information of a document, a fifth section having data of sharing target information (use right information) of a document or a sixth section having hash data of a document. In addition, it may include information representing whether to determine whether a document is duplicate, information representing whether a use rate of a document is determined, classification information of a document, etc.

In addition, a header of a document may further include a section table indicating information represented by values of each section of a header. In other words, simply discretized information is stored in each section, so meaning, use, etc. of each section may be determined by a section table. Accordingly, a control unit of a server or a client may utilize data of a desired section by referring to the section table.

A payload of a document may store substantive data of a document or encoding data that data of a document itself is encoded.

A header of a document may have a one-to-one relationship with a payload, but it may also have a one-to-many relationship. As an example, when at least two payloads are connected to one header, all of the payloads may have the same metadata included in the header.

Sections of a header of a document may vary depending on importance of a document and importance of a document may be determined based on document classification information which is metadata of a document.

When a value of a section of a first header of a document is the same as a value of a section of a second header preceding the first header, a value of a section of the first header may be omitted or may include a point value indicating a section of a second header.

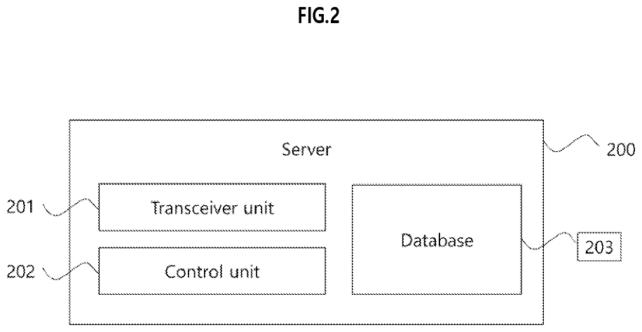

FIG. 2 is an exemplary diagram showing a structure of a server.

A server 200 may include at least one of a transceiver unit 201, a control unit 202 or a database of a server 203.

A transceiver unit 201 of a server may transmit/receive document data between a corresponding server and other server or clients.

A control unit 202 of a server may include a user management module managing a user, a synchronization module synchronizing a document with other server or clients, a document usability determination module determining whether a document is duplicate and a use rate of a document, etc.

A database 203 of a server may store document data. In this case, a database of a server may be divided according to document data. As an example, a database of the server may be divided according to importance of a document or whether a document is encrypted. As an example, a database of the server may be divided into a first database which stores basic information identifying a document and a second database which stores additional information of a document. As such, when a database of a server is divided, a data connection between sub-databases included in a database of a server may be performed by using basic information identifying a document as key information.

When a document is registered on a server, a control unit 202 of a server may perform at least one of determining whether a document is duplicate or determining whether substantive contents of a document are the same. Here, a case in which a document is registered on a server may include a case in which new document data is newly stored in a database 203 of a server, a case in which a version of a document in a database of a server is changed, a case in which metadata of a document in a database of a server is changed and others.

A determination on whether a document is duplicate may be performed based on a unique identification value of a document and a version of a document.

As an example, when a unique identification value of both documents, a comparison target, is different, a control unit may determine that the both documents are a non-duplicate document. In this case, a control unit may register a document which is newly registered on a server on a server (store it in a database of a server).

As an example, when a unique identification value of both documents, a comparison target, is the same, a control unit may further determine whether a version of the both documents is the same. If a version of the both documents is different, a control unit may determine that the both documents are a non-duplicate document. If a version of the both documents is the same, a control unit may determine that the both documents are a duplicate document. In this case, a control unit may skip a document which is newly registered on a server without registering it on a server.

A determination on whether substantive contents of a document are the same may be performed based on hash data of a document.

As an example, when hash data of documents to be compared is the same, a control unit may determine that substantive contents of the documents to be compared are the same. In this case, a control unit may support deleting any one of the documents to be compared. The support may be performed by a method such as a message or a mail, etc. to a user.

As an example, when hash data of documents to be compared is different from each other, a control unit may determine that substantive contents of the documents to be compared are different. In this case, a control unit may register a document which is newly registered on a server on a server (store it in a database of a server).

When a document is registered on a server, a control unit 202 of a server may first determine whether a document is duplicate and then determine whether substantive contents of a document are the same. But, the present disclosure is not limited thereto, so a control unit may determine whether a document is duplicate after determining whether substantive contents of a document are the same.

As an example, only when both documents are determined to be a duplicate document and substantive contents of both documents are determined to be the same, a control unit may skip a document which is newly registered on a server without registering it on a server.

As an example, when both documents are determined to be a duplicate document and substantive contents of both documents are determined to be the same, a control unit may skip a document which is newly registered on a server without registering it on a server.

As an example, only when both documents are not determined to be a duplicate document and substantive contents of both documents are determined to be different, a control unit may register a document which is newly registered on a server on a server (store it in a database of a server).

A control unit 202 of a server may determine a use rate of a document periodically or upon request.

A determination on a use rate of a document may be performed by considering use information of a document for a specific period (e.g., 1 year). Use information of a document may include the number of uses of a document, a frequency of use, a use period and a use pattern. Here, a use pattern of a document may be information determined based on at least one of the number of uses of a document, a frequency of use or a use period.

As an example, a use pattern of a corresponding document may be determined by analyzing a frequency of use and a use period of a document for one year. If it is used frequently for a short period of time and subsequently, it is not used for a long period of time, a corresponding document has a very low use rate, and in this case, a past version of a document may not mean much. Conversely, if a document is not used frequently, but it is used for a certain period of time, a version of a corresponding document may mean much.

Use information of a document may be monitored as metadata of a document related to the use information is changed when using a document. For example, each time a document is used, a value of the number of uses of a document of metadata of a document may be increased. In addition, data on a use date of a document may be added to metadata of a document for a use period a document.

According to a determination on a use rate of a document, a document which is not used for a certain period of time may be divided as a removal target. As an example, when a use rate of a document is smaller than a threshold value, the document may be identified as a document to be removed. In contrast, when a use rate of a document is greater than or equal to a threshold value, the document may not be identified as a document to be removed.

Whether a document is subject to removal may be performed by adding or modifying a value of information related to a removal target to metadata of the document. Here, a certain period of time may be determined according to importance of a document. As importance of a document is a pre-defined value, it may be identified through classification information of a document of metadata of a document. Importance of a document may have a one-to-one relationship with classification information of a document, but it may also have a one-to-many relationship. For example, when there is 5 classification information of a document {A, B, C, D, E}, importance of a document of {A, B} may be level 1, importance of a document of {C} may be level 2 and importance of a document of {D, E} may be level 3. A relationship between importance of a document and classification information of a document may be modified according to a request of a server or an authorized client.

A document divided as a removal target may be deleted immediately or may be deleted upon request according to importance of a document. As an example, a document whose importance value is smaller than a threshold value may be immediately deleted if it is divided as a removal target. As an example, a document whose importance value is equal to or greater than a threshold value may be deleted according to a request of a server or an authorized client without being deleted immediately although it is divided as a removal target. In this case, a control unit may support a server or an authorized client to remove a document to be removed.

In conclusion, a control unit 202 of a server may efficiently manage a document by determining whether a document is duplicate or whether substantive contents of a document are the same and may efficiently manage storage space of a database of a server by determining a use rate of a document and identifying a document to be removed.

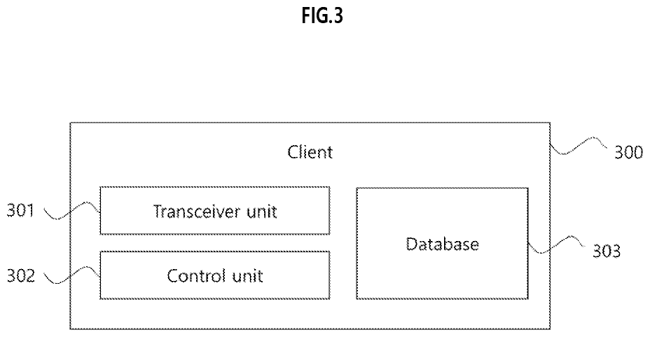

FIG. 3 is an exemplary diagram showing a structure of a client.

A client 300 may include at least one of a transceiver unit 301, a control unit 302 or a database of a server 303.

A client transceiver unit 301 may transmit/receive document data between a corresponding client and a server or other clients.

A control unit 302 of a client may include a synchronization module which synchronizes a document with a server or other clients, a document usability determination module which determines at least one of whether a document is duplicate, whether substantive contents of a document are the same or a use rate of a document and others.

A database 303 of a client may store document data. As an example, at least one of data of a document itself or metadata of a document may be stored. In this case, a database of a client may be divided according to document data. As an example, a database of the client may be divided according to importance of a document or whether a document is encrypted. As an example, a database of the client may be divided into a first database which stores basic information identifying a document and a second database which stores additional information of a document. As such, when a database of a client is divided, a data connection between sub-databases included in a database of a client may be performed by using basic information identifying a document as key information.

When a document with metadata is downloaded from a server or another client, a control unit 302 of a client may perform at least one of determining whether a corresponding document is duplicate or determining whether substantive contents of a document are the same.

A control unit may store document data of a downloaded document in a temporary memory or a database of a client. Subsequently, a control unit may determine whether the document is a duplicate document of an existing document based on a unique identification value and version information of a document among metadata of the document. Here, an existing document may include an existing document stored in a database of a client and an existing document identified by metadata of a document in a database of a client. For convenience of a description, it is described below only as an existing document.

As an example, when a unique identification value and version information of a downloaded document are the same as an existing document of a database of a client, a control unit may delete document data of a downloaded document from a temporary memory or a database of a client or skip download.

As an example, when a downloaded document has the same unique identification value as an existing document of a database of a client, but both documents have different version information, a control unit may update document data of an existing document to document data of a downloaded document when version information of a downloaded document is higher than version information of an existing document.

As an example, when a downloaded document has the same unique identification value as an existing document of a database of a client, but both documents have different version information, a control unit may store document data of both a downloaded document and an existing document in a database of a client. In this case, document data of an existing document may not be updated (document data of an existing document may be updated separately when an existing document is used).

A control unit may perform a determination on whether substantive contents are the same which represents whether contents of the document are substantially the same as those of an existing document based on hash data of a document.

As an example, when hash data of documents to be compared is the same, a control unit may determine that substantive contents of the documents to be compared are the same. In this case, a control unit may support deleting document data of any one of the documents to be compared. The support may be performed by a method such as a message or a mail, etc. to a user.

As an example, when hash data of documents to be compared is different from each other, a control unit may determine that substantive contents of the documents to be compared are different. In this case, a control unit may store document data of both a downloaded document and an existing document in a database of a client. In this case, document data of an existing document may not be updated.

When a document with metadata is downloaded from a server or another client, a control unit 302 of a client may first determine whether a document is duplicate and then determine whether substantive contents of a document are the same. But, the present disclosure is not limited thereto, so a control unit may determine whether a document is duplicate after determining whether substantive contents of a document are the same.

As an example, only when both documents are determined to be a duplicate document and substantive contents of both documents are determined to be the same, a control unit may skip document data of a downloaded document without storing it.

As an example, when both documents are determined to be a duplicate document or substantive contents of both documents are determined to be the same, a control unit may skip document data of a downloaded document without storing it.

As an example, only when both documents are not determined to be a duplicate document and substantive contents of both documents are determined to be different, a control unit may store document data of a downloaded document in a database.

A control unit 302 of a client may store or renew metadata (e.g., a storage location, a document unique identification value, version information, etc.) of the document when using (e.g., reading) a document.

When a document of a database of a client is modified, a control unit 302 of a client may transmit document data of the modified document to a server according to a request of a user. When a request to transmit document data of the modified document to a server (a check-in request) is received from a user, the control unit may transmit document data of the modified document to a server. In contrast, when a request to transmit document data of the modified document to a server (a check-in request) is not received from a user, the control unit may not transmit document data of the modified document to a server.

A control unit 302 of a client may periodically determine validity of a document of a database of a client. Specifically, a control unit may transmit a unique identification value of the document to a server per specific period. When there is a document which has the same unique identification value as a unique identification value of the document in a database of a server, the control unit may determine that the document is a valid document. On the contrary, when there is no document which has the same unique identification value as a unique identification value of the document in a database of a server, the control unit may determine that the document is an invalid document. Here, a specific period may be determined according to importance of a document, and a description on importance of a document is described above, so it is omitted.

A control unit 302 of a client may delete a document determined as an invalid document or transmit a deletion request message to a user so that a user can clean it.

A control unit 302 of a client may not modify metadata of the document although there is a request to copy document data of a client database within a client database or to a backup device. Even in this case, if metadata is modified, there is a problem that too many system resources are used, which leads to a decline in system use. Since most users have a pattern of storing a document and attempting to read it immediately, metadata of a document may be fully managed efficiently although metadata of a document is managed in reading a document.

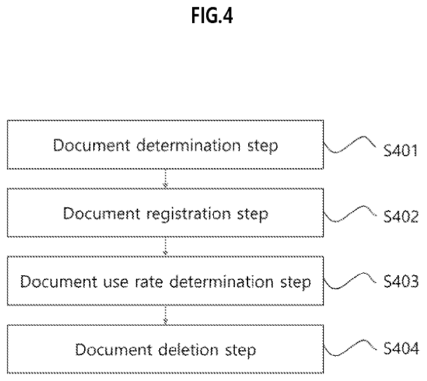

FIG. 4 is a diagram for a method for managing a document to be cleaned of a server. A method for managing a document to be cleaned of a server may include at least one of a document determination step S401 of determining at least one of whether a document is duplicate or whether a document is substantially the same according to a request to register a document, a document registration step S402 of registering a document on a server based on the document determination result, a document use rate determination step S403 of determining a use rate of a document registered on a server or a document deletion step S404 of deleting a document according to a use rate determination result.

In a document determination step S401 of determining at least one of whether a document is duplicate or whether a document is substantially the same according to a request to register a document, a request to register a document may include a request to store document data of a document in a database of a server according to a request of a server or a client.

A determination on whether a document is duplicate may be performed based on a unique identification value of a document and a version of a document.

As an example, when a unique identification value of both documents, a comparison target, is different, the both documents may be determined as a non-duplicate document.

As an example, when a unique identification value of both documents, a comparison target, is the same, whether a version of the both documents is the same may be further determined. If a version of the both documents is different, the both documents may be determined as a non-duplicate document. If a version of the both documents is the same, the both documents may be determined as a duplicate document.

A determination on whether substantive contents of a document are the same may be performed based on hash data of a document.

As an example, when hash data of documents to be compared is the same, it may be determined that substantive contents of the documents to be compared are the same.

As an example, when hash data of documents to be compared is different from each other, it may be determined that substantive contents of the documents to be compared are different.

In a document registration step S402 of registering a document on a server based on the document determination result, in a relationship with an existing document stored in a database, when a registered document is determined as a non-duplicate document, a corresponding document may be registered on a server (stored in a database of a server).

Alternatively, in a relationship with an existing document stored in a database, when substantive contents of a registered document are determined to be different, a corresponding document may be registered on a server (stored in a database of a server).

Alternatively, in a relationship with an existing document stored in a database, only when a registered document is determined as a non-duplicate document and substantive contents of a registered document are determined to be different, a corresponding document may be registered on a server (stored in a database of a server).

In a document registration step S402 of registering a document on a server based on the document determination result, in a relationship with an existing document stored in a database, when a document which is newly registered on a server is determined as a duplicate document, a document which is newly registered on a server may be skipped without being registered on a server.

Alternatively, in a relationship with an existing document stored in a database, when substantive contents of a registered document are determined to be the same, a document which is newly registered on a server may be skipped without being registered or a registered document may be registered on a server, but any one of an existing document and a registered document may be supported to be deleted.

Alternatively, in a relationship with an existing document stored in a database, only when a registered document is determined as a duplicate document and substantive contents of a registered document are determined to be the same, a document which is newly registered on a server may be skipped without being registered or a registered document may be registered on a server, but it may be supported so that any one of an existing document and a registered document is deleted.

In a document use rate determination step S403 of determining a use rate of a document registered on a server, a determination on a use rate of a document may be performed by considering document use information for a specific period (e.g., 1 year). Use information of a document may include the number of uses of a document, a frequency of use, a use period and a use pattern. Here, a use pattern of a document may be information determined based on at least one of the number of uses of a document, a frequency of use or a use period.

As an example, a use pattern of a corresponding document may be determined by analyzing a frequency of use and a use period of a document for one year. If it is used frequently for a short period of time and subsequently, it is not used for a long period of time, a corresponding document has a very low use rate, and in this case, a past version of a document may not mean much. Conversely, if a document is not used frequently, but it is used for a certain period of time, a version of a corresponding document may mean much.

Use information of a document may be monitored as metadata of a document related to the use information is changed when using a document. For example, each time a document is used, a value of the number of uses of a document of metadata of a document may be increased. In addition, data on a use date of a document may be added to metadata of a document for a use period a document.

In a document deletion step S404 of deleting a document according to a use rate determination result, a document which is not used for a certain period of time may be divided as a removal target according to a document use rate determination. As an example, when a use rate of a document is smaller than a threshold value, the document may be identified as a document to be removed. In contrast, when a use rate of a document is greater than or equal to a threshold value, the document may not be identified as a document to be removed.

Whether a document is subject to removal may be performed by adding or modifying a value of information related to a removal target to metadata of the document. Here, a certain period of time may be determined according to importance of a document. As importance of a document is a pre-defined value, it may be identified through classification information of a document of metadata of a document. Importance of a document may have a one-to-one relationship with classification information of a document, but it may also have a one-to-many relationship. For example, when there is 5 classification information of a document {A, B, C, D, E}, importance of a document of {A, B} may be level 1, importance of a document of {C} may be level 2 and importance of a document of {D, E} may be level 3. A relationship between importance of a document and classification information of a document may be modified according to a request of a server or an authorized client.

Document data of a document divided as a removal target may be deleted immediately or may be deleted upon request according to importance of a document. As an example, document data of a document whose importance value is smaller than a threshold value may be deleted immediately when it is divided as a removal target. As an example, a document whose importance value is equal to or greater than a threshold value may be deleted according to a request of a server or an authorized client without being deleted immediately although it is divided as a removal target. In this case, a server or an authorized client may be supported to remove document data of a document to be removed.

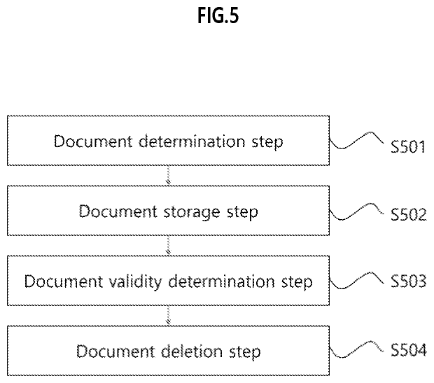

FIG. 5 is a diagram for a method for managing a document to be cleaned of a client.

A method for managing a document to be cleaned of a client may include at least one of a document determination step S501 of determining at least one of whether a document is duplicate or whether a document is substantially the same according to download of a document, a document storage step S502 of storing document data of a document in a client based on the document determination result, a document validity determination step S503 of determining validity of document data in a client or a step S504 of deleting a document according to a validity determination result.

In a document determination step S501 of determining at least one of whether a document is duplicate or whether a document is substantially the same according to download of a document, download of a document may include a case in which a document with metadata is downloaded from a server or another client.

A determination on whether a document is duplicate may be performed based on a unique identification value of a document and a version of a document. A determination of duplication based on a unique identification value and version information of a document is described above, so it is omitted.

A determination on whether substantive contents of a document are the same may be performed based on hash data of a document. A determination on whether substantive contents of a document are the same based on hash data of a document is described above, so it is omitted.

In a document storage step S502 of storing document data of a document in a client based on the document determination result, storage of document data of a document may include storing document data of the document in a database of a client.

In a document storage step S502, in a relationship with document data of an existing document stored in a database, when a downloaded document is determined as a non-duplicate document, document data of a downloaded document may be stored in a database of a client. But, when an identification value of a document is the same, but only version information is different, document data of an existing document may be updated to document data of a downloaded document. The update may include changing contents of an existing document to a downloaded document and changing version information to a version higher than that of an existing document. Alternatively, it may include changing only version information of a document.

Alternatively, in a relationship with an existing document stored in a database, when substantive contents of a downloaded document is determined to be different, document data of a downloaded document may be stored in a database of a client.

Alternatively, in a relationship with an existing document stored in a database, only when a downloaded document is determined as a non-duplicate document and substantive contents of a downloaded document are determined to be different, document data of a downloaded document may be stored in a database of a client.

In a document storage step S502 of storing document data of a document in a client based on the document determination result, in a relationship with an existing document stored in a database, when a downloaded document is determined as a duplicate document, document data of a downloaded document may not be stored in a database of a client and download may be skipped.

Alternatively, in a relationship with an existing document stored in a database, when substantive contents of a downloaded document are determined to be the same, document data of a downloaded document may not be stored in a database of a client and download may be skipped or document data of a downloaded document may be stored in a database of a client, but document data of any one of an existing document and a downloaded document may be supported to be deleted.

Alternatively, in a relationship with an existing document stored in a database, only when a downloaded document is determined as a duplicate document and substantive contents of a downloaded document are determined to be the same, document data of a downloaded document may not be stored in a database of a client and download may be skipped or document data of a downloaded document may be stored in a database of a client, but document data of any one of an existing document and a downloaded document may be supported to be deleted.

In a document validity determination step S503 of determining validity of a document in a client, validity of a document of a database of a client may be periodically determined. To determine the validity, a unique identification value of the document may be periodically transmitted to a server.

When there is a document which has the same unique identification value as a unique identification value of the document in a database of a server, the document may be determined as a valid document. On the contrary, when there is no document which has the same unique identification value as a unique identification value of the document in a database of a server, the control unit may determine that the document is an invalid document. Here, a specific period may be determined according to importance of a document, and a description on importance of a document is described above, so it is omitted.

In a document deletion step S504 of deleting a document according to a validity determination result, when the document is determined as an invalid document, document data of the document may be deleted or a deletion request message may be transmitted to a user so that document data of the document is deleted by a user.

A method of managing a document to be cleaned based on metadata of a secure document according to an embodiment of the present disclosure may be implemented by a computer readable recording medium including a program instruction for performing a variety of operations implemented by a computer. The computer readable recording medium may include a program instruction, a local data file, a local data structure, etc. alone or in combination. The recording medium may be specially designed and configured for an embodiment of the present disclosure or may be used by being notified to those skilled in computer software. An example of a computer readable recording medium includes magnetic media such as a hard disk, a floppy disk and a magnetic tape, optical recording media such as a CD-ROM, a DVD, etc., magneto-optical media such as a floptical disk, and a hardware device which is specially configured to store and perform a program instruction such as ROM, RAM, a flash memory, etc. The recording medium may be a transmission medium such as an optical or metallic line, a wave guide, etc. including a carrier transmitting a signal designating a program instruction, a local data structure, etc. An example of a program instruction may include a high-level language code which may be executed by a computer using an interpreter, etc. as well as a machine language code generated by a compiler.

As a description above is just an illustrative description for a technical idea of the present disclosure, it may be changed and modified in various ways by those with ordinary skill in the art to which the present disclosure pertains within a scope not departing from an essential characteristic of the present disclosure. In addition, embodiments disclosed in the present disclosure are intended not to limit, but to explain a technical idea of the present disclosure, and a scope of a technical idea of the present disclosure is not limited by these embodiments. Accordingly, a protection scope of the present disclosure should be interpreted by claims below, and all technical ideas within a scope equivalent thereto should be interpreted as being included in a scope of a right of the present disclosure.

1. A device for managing a document to be cleaned, the device comprising:
a database storing document data of a document, wherein metadata of the document data includes a unique identification value identifying the document, version information representing a version of the document, and hash data related to contents of the document; and
a control unit for processing a request, in response to the request to store document data of a first document in the database, based on at least one of whether the first document is duplicate or whether substantive contents of the first document are a same in a relationship with a second document pre-stored in the database,
wherein whether the first document is duplicate is determined by comparing the unique identification value and version information of the first document with the unique identification value and version information of the second document,
wherein whether substantive contents of the first document are the same is determined by comparing hash data of the first document with hash data of the second document.

2. The device of claim 1, wherein:
when the unique identification value and version information of the first document are the same as the unique identification value and version information of the second document, in the relationship with the second document, the first document is determined as a duplicate document,
when at least one of the unique identification value or version information of the first document and the second document is different, in the relationship with the second document, the first document is determined as a non-duplicate document.

3. The device of claim 2, wherein:
when hash data of the first document is the same as hash data of the second document, substantive contents of the first document are determined to be the same as the second document,
when hash data of the first document is different from hash data of the second document, substantive contents of the first document are determined to be different from the second document.

4. The device of claim 3, wherein:
when the device for managing the document to be cleaned is a server, the first document is the document requested to be registered on the server by a client connected to the server or the server,
the request to store document data of the first document in the database includes the request to store document data of the first document in the database of the server.

5. The device of claim 3, wherein:
when the device for managing the document to be cleaned is a client connected to a server, the first document is the document downloaded from the server,
the request to store document data of the first document in the database includes the request to store document data of the first document in the database of the client.

6. The device of claim 5, wherein:
when document data of the first document is stored in the database of the client according to the request to store document data of the first document in the database,
validity of the first document stored in the database of the client is determined based on the unique identification value of the first document per certain period.

7. The device of claim 1, wherein:
when the request to store document data of the first document in the database is performed,
the control unit determines a use rate of the first document per certain period.

8. The device of claim 7, wherein:
metadata of the document further includes document classification information representing a type of the document,
the certain period is determined according to importance of the first document,
importance of the first document is determined based on document classification information of the first document.

9. The device of claim 8, wherein:
metadata of the document further includes a frequency of use and a use period of the document,
a determination on the use rate of the first document is performed based on the frequency of use and the use period of the first document.

10. The device of claim 9, wherein:
when the use rate of the first document is smaller than a threshold value,
the control unit identifies the first document as the document to be removed and delete it from the database.

11. A method for managing a document to be cleaned, the method comprising:
processing a request, in response to the request to store document data of a first document in a database, based on at least one of whether the first document is duplicate or whether substantive contents of the first document are a same in a relationship with a second document pre-stored in the database,
wherein whether the first document is duplicate is determined by comparing a unique identification value and version information of the first document with the unique identification value and version information of the second document,
wherein whether substantive contents of the first document are the same is determined by comparing hash data of the first document with hash data of the second document.

12. The method of claim 11, wherein:
when the request is performed, validity of the first document stored in the database is determined based on the unique identification value of the first document per certain period.

13. The method of claim 11, wherein:
when the request is performed, a use rate of the first document stored in the database is determined based on a frequency of use and a use period of the first document per certain period.

14. The method of claim 13, wherein:
the certain period is determined according to importance of the first document,
importance of the first document is determined based on document classification information representing a type of the first document.

15. The method of claim 14, wherein:
when the use rate of the first document is smaller than a threshold value, the first document is identified as the document to be removed and is deleted from the database.

16. A non-transitory computer readable recording medium, wherein a computer program for executing a method according to claim 11 by a computer is recorded.
